(19) United States
(12) Patent Application Publication
(10) Pub. No.: US 2012/0278991 A1
(43) Pub. Date: Nov. 8, 2012

(54) SUPPORT PILLOWS WITH LABELS

(75) Inventors: Clarice Bonzer, Littleton, CO (US); Charles Parker, Englewood, CO (US); Nancy Bartley, Golden, CO (US)

(73) Assignee: The Boppy Company, LLC, Golden, CO (US)

(21) Appl. No.: 13/487,060

(22) Filed: Jun. 1, 2012

Related U.S. Application Data
(63) Continuation-in-part of application No. 13/101,611, filed on May 5, 2011.

(51) Int. Cl. A47D 15/00; G09F 3/00; A47G 9/02; A47G 9/10

(52) U.S. Cl. 5/636; 5/655

(57) ABSTRACT

A multi-use pillow is constructed of a pillow body having a medial region and two arms that extend from the medial region. The pillow body also has a curved exterior periphery and an interior periphery that defines a well. A plurality of use-defining images are positioned on the pillow. Also, numeric indicia may also be placed on the pillow body adjacent to each of the use-defining images. In this way, a user is provided with a variety of visual prompts about how the pillow may be used.

### CROSS REFERENCES TO RELATED APPLICATIONS

This application is a continuation in part application and claims the benefit of copending U.S. patent application Ser. No. 13/101,611, filed May 5, 2011, the complete disclosure of which is herein incorporated by reference.

### BACKGROUND OF THE INVENTION

This invention relates generally to the field of pillows. In particular, the invention relates to pillows having a wide variety of uses. In some embodiments, such pillows are provided with various indicia suggestive of how the pillow may be used.

Over the years, a variety of support pillows have found commercial acceptance. One exemplary support pillow is the Boppy® pillow, marketed by The Boppy Company. Various forms of this pillow are described in U.S. Pat. Nos. 5,261,134; 5,546,620; 5,661,861; and 6,055,657, among others. The complete disclosures of these patents are incorporated herein by reference.

One advantage of such pillows is their versatility, particularly with respect to a variety of uses. For example, such pillows are commonly used to prop a baby or to facilitate nursing. Hence, this invention is related to techniques to facilitate even greater usage of such pillows.

### BRIEF SUMMARY OF THE INVENTION

In one embodiment, a multi-use pillow comprises a pillow body having a medial region and two arms that extend from the medial region. The pillow body has a curved exterior periphery and an interior periphery that defines a well. A plurality of use-defining images are positioned on the pillow body that assist in illustrating different uses of the pillow. Numeric indicia are also placed adjacent the use-defining images giving a suggested age for the associated use.

In one aspect, the pillow body comprises a fabric shell encasing a fill material, and the use-defining images are printed onto the shell. As one example, the shell may comprise a top piece, a bottom piece and a gusset disposed between the top piece and the bottom piece at the inner periphery, and the use-defining images may be included on the gusset. In some cases, the use-defining images may be placed solely on the gusset so as not be included on the top piece or the bottom piece, thus reducing manufacturing costs. In some aspects, the gusset is constructed of a fabric cut on the bias having a weft and a weave such that the use-defining images are disposed at a 45 degree angle relative to the weft and the weave. However, it will be appreciated that the use-defining images could also be positioned elsewhere, such as at locations indicative of where a particular use of the pillow may occur.

In one aspect, use-defining text is provided on the pillow body adjacent to each of the use-defining images. The use-defining text describes the particular use associated with each of the use-defining images.

A variety of uses may be depicted. Examples of uses include sitting upright within the well, laying face up within the well while being propped by the medial region. feeding atop the pillow, laying prone, and the like.

In some aspects color-coding schemes may be used to color coordinate the use-defining images, the numeric indicia and any text. Also, the use-defining images may be provided at multiple locations. Further, a slipcover may be disposed about the pillow body.

A further embodiment provides an exemplary method for using a pillow. The method utilizes a pillow body comprising a medial region and two arms that extend from the medial region. The pillow body has a curved exterior periphery and an interior periphery that defines a well, and the pillow body includes a plurality of use-defining images positioned on the pillow body and numeric indicia adjacent the use-defining images giving a suggested age for the associated use. A baby is positioned at least partially on the pillow body or within the well in a position depicted in one of the use-defining images. When needed, the position of the baby is readjusted relative to the pillow such that the baby is in a position similar to another one of the use-defining images.

In another exemplary embodiment, a multi-use pillow comprises a pillow body having a medial region and two arms that extend from the medial region. The pillow body also has a curved exterior periphery and an interior periphery that defines a well. A plurality of use-defining images are positioned on the pillow body at locations indicative of where a particular use of the pillow may occur. Also, use-defining text may be placed on the pillow body adjacent to each of the use-defining images. In this way, a user is provided with a variety of visual prompts about how the pillow may be used. For example, the use-defining image itself depicts how the pillow can be used. Further, the location of the use-defining image is suggestive of a use by indicating a particular location or region of the pillow involved with the use. Still further, the use-defining text describes the particular use associated with each of the use-defining images. In some cases, the pillow may include only use-defining images, only use-defining text, or a combination of both. Also, such information may be included on the top surface, on the bottom surface, or on both.

As one example, the particular use may comprise sitting upright within the well, and the use-defining image may depict a baby sitting upright in a well of a pillow. Also, the use-defining image of the baby sitting in the well of the pillow may be located at the medial region near the interior periphery.

As another example, the particular use may comprise laying face up or supine within the well while being propped by the medial region, and the use-defining image may depict a baby being propped by a pillow. The use-defining image of the baby being propped may be located at the medial region near the exterior periphery.

In yet another example, the particular use may comprise feeding, and the use-defining image may depict a baby resting atop a pillow. The use-defining image of feeding may be located along at least one of the arms. In some cases, the image may be on both of the arms.

In still another example, the particular use may comprise laying prone, and the use-defining image may depict a baby laying prone on a pillow. The use-defining image of the baby laying prone may be located at the medial region between the interior periphery and the exterior periphery.

Optionally, the use-defining images and the use-defining text may be color coded, with corresponding images and text being of the same color. Also, the use-defining text may be provided in a plurality of languages. In another option, the use-defining text may be provided at multiple locations near each use-defining image.

To further suggest proper usage, numeric indicia may be provided adjacent each use-defining image. The numeric indicia give a suggested age for the associated use.

In one arrangement, the pillow body comprises a fabric shell encasing a fill material, and the use-defining images are printed onto the shell. In some cases, a slipcover is disposed about the pillow body.

The invention also provides an embodiment of a slipcover for a multi-use pillow. The slipcover comprises a cover body forming an open interior that is adapted to receive a pillow. The cover body comprises a medial region and two arms that extend from the medial region. The pillow body has a curved exterior periphery and an interior periphery that defines a well. The cover body includes an opening providing access to the interior. A label is coupled to the cover body and includes a plurality of use-defining images indicative of a particular use of the pillow. Also, use-defining text is adjacent to each of the use-defining images. The use-defining text describes the particular use associated with each of the use-defining images.

In one arrangement, the label is sewn into a seam of the cover body. Optionally, numeric indicia may be adjacent each use-defining image giving a suggested age for the associated use.

The invention further provides an exemplary method for using a pillow. The method utilizes a pillow similar to the other pillows described herein. After reading the use-defining images, a particular use is selected and a baby is positioned at least partially on the pillow body over one of the use-defining images in a position depicted in the use-defining image. After the initial use, the position of the baby may be readjusted relative to the pillow such that the baby is at least partially on the pillow body over another one of the use-defining images in a different position.

### BRIEF DESCRIPTION OF THE DRAWINGS

FIG. 1 is a top perspective view of one embodiment of a multi-use pillow according to the invention.

FIG. 2 is a top view of the pillow of FIG. 1.

FIG. 3 is a bottom view of the pillow of FIG. 1.

FIG. 4 illustrates one use of the pillow of FIG. 1 to hold a baby in a sitting position.

FIG. 5 illustrates another use of the pillow of FIG. 1 when feeding a baby.

FIG. 6 illustrates still another use of the pillow of FIG. 1 when propping a baby according to the invention.

FIG. 7 illustrates yet another use of the pillow of FIG. 1 when a baby is lying on his stomach according to the invention.

FIG. 8A illustrates one embodiment of a slipcover placed about the pillow of FIG. 1.

FIG. 8B is a detailed view of a label of the slipcover of FIG. 8A.

FIG. 8C illustrates another embodiment of a slipcover placed about the pillow of FIG. 1.

FIG. 8D is a detailed view of a label of the slipcover of FIG. 8C.

FIG. 9 a top perspective view of another embodiment of a multi-use pillow according to the invention.

FIG. 10 is a more detailed view of the labeling on the gusset of the pillow of FIG. 9.

### DETAILED DESCRIPTION OF THE INVENTION

The invention provides various pillows that may be used in a variety of ways, usually in association with the care of a baby. Merely by way of example, the pillows of the invention may be used to prop a baby, either prone or upright, to place the baby in a sitting position, to assist with nursing or feeding and the like.

In one particular arrangement, the pillows may be constructed of a medial region and two opposing arms that may be widely separated from each other without damaging or permanently distorting the pillow. When the arms are released, they spring back to their original position. This permits the pillow to be placed about large objects, with the arms tensioned against the object, yet not uncomfortably. For example, when the ends of the pillow arms are separated enough to be placed about the torso of an average sized adult, the inward force produced by each arm is sufficient to hold the pillow in place about the torso, yet not so tight that it is uncomfortable. Further, when the pillow clings about a relatively large object, the medial region does not buckle, but keeps its shape. When removed, the pillow's resilience permits it to spring back to its original shape, typically with the ends being separated by about 8 inches or less, and in some cases about 4 inches or less and in other cases about 2 inches or less.

To construct the pillow, a cover or shell is used to surround a fill material. In some cases, the cover may include a central panel surrounding the well. The fill material used to make the pillow may be such that the pillow is relatively firm when filled, particularly so that the pillow will not significantly deflect under the weight of a baby. Examples of materials that may be used include polyester fibers, foamed materials, and the like. One method for filling the cover with a fill material is described in U.S. Pat. No. 7,089,639, which is incorporated herein by reference.

The cover may be constructed of a main portion using one or more pieces of fabric and a center panel at the inner periphery of the pillow. The overall shape of the pillow may be similar to those described in U.S. Pat. Nos. 5,261,134, 5,661,861, 5,546,620 and 6,055,687; 6,685,024; 6,434,770; 6,671,908; 7,017,212; 6,279,185; 6,412,128; 7,451,508; 7,127,760; 6,944,898; 7,587,773; 7,472,443; and 7,404,222, and U.S. patent application Ser. No. 13/071,358, filed Mar. 24, 2001 and entitled “Travel Nursing Pillow,” incorporated herein by reference. The main portion of the cover or shell may, in some cases, be constructed of two or more pieces of material which are sewn to each other, with the center panel being sewn to the main portion, although other coupling techniques may be used, such as by using a fabric glue. Some techniques for attaching a center panel of material to a cover is also described in U.S. Pat. No. 6,412,128 and U.S. Patent Publication No. 2008/0010750, which are incorporated herein by reference. For example, the center panel may be constructed of a woven material having a weft and a weave. The center panel may be cut on the bias and coupled to the top piece and the bottom piece so that the center panel will be elastic, i.e., resiliently expand and contract, when the arms are pulled apart from each other and released. Such a construction is described in the previously-mentioned patents and published application. As described hereinafter, versatility messaging, such as use-defining images, numeric indicia, text and the like, may be provided on the center panel.

The material used to construct the main portion of the cover and/or the center panel may be a fabric, such as cotton, polyester, velvet, chiffon and the like. Such fabrics permit the pillow to be firmly stuffed with fill materials. When stuffed in this manner, the pillows are able to maintain their shape for extended time periods. Such fabrics also provide an aesthetically pleasing surface.

The support pillows of the invention may find use with a variety of applications where the arms are manipulated to be placed around an object. Merely by way of example, such applications may include placement about a torso to facilitate nursing, the holding of an object, such as a book, a toy, food, or the like, to function as a back support, or the like. The support pillows of the invention may also find use with the applications described in U.S. Pat. Nos. 5,261,134, 5,661,861, 5,546,620 and 6,055,687; 6,685,024; 6,434,770; 6,671,908; 7,017,212; 6,279,185; 6,412,128; 7,451,508; 7,127,760; 6,944,898; 7,587,773; 7,472,443; and 7,404,222, previously incorporated herein by reference.

Many users of these and other pillows are unaware of their different possible uses. For example, a consumer may purchase the pillow for nursing or feeding and not realize that it may also be used to prop a baby. If a user were able to realize the various uses, the value of the pillow may increase. Also, the pillow could be used more often and over longer periods of time.

To facilitate the conveyance of such information to a purchaser or user, multi-use pillows may be provided with versatility messaging. This messaging may be done by using words, symbols and/or illustrations or the like that are included directly on the pillow and/or on a label or tag associated with the pillow. For example, this information could be printed directly onto the pillow's fabric that is then cut and sewn to make the pillow skin. The messaging information is designed to easily and permanently convey to the user that the multi-use pillow has a variety of uses. Merely by way of example, the multi-use pillows may be used as a support during feeding, for propping an infant, for positioning an infant on his stomach (also referred to as tummy time), and/or as a support to assist the baby as he learns to sit, among other uses. Optionally each of these uses may be depicted on the pillow using a different color. Further, an illustration in an accompanying color along with simple descriptive wording may be shown on the section or zone of the pillow that will be used for the given purpose. For example, an illustration of a baby feeding may be placed on one of the arms where the baby is typically positioned when feeding. The language “feeding” may be used to describe the use. Also, a number, such as “0”, or “0 M”) could be provided to indicate that this use is good for newborn babies (0 months) and older. In some cases, the descriptive language may also be translated into multiple languages. By placing this information directly onto the pillow, the user is able to visualize the messaging immediately after removing the pillow from its packaging and will therefore be educated on the various uses of the pillow.

In many cases, a slipcover will be placed about the pillow, thereby hiding the versatility messaging. However, each time the slipcover is removed (such as for washing), the user will once again see the versatility messaging and will be reminded of the different uses. Further, the slipcover itself may also include versatility messaging. As one option, the versatility messaging could be printed onto the slipcover like with the pillow. As another option, at least some of the versatility messaging may be printed onto a label or tag that is coupled to the slipcover, such as by sewing it into the seam. This tag may include illustrations with simple word descriptions that may optionally be included in multiple languages. Also, numbers may be used to indicate a suggested age. As another option, the tag may include color coding which corresponds to similarly colored locations or zones on the pillow where the suggested usage may occur. Further, messaging may be included on one or both sides of the tag.

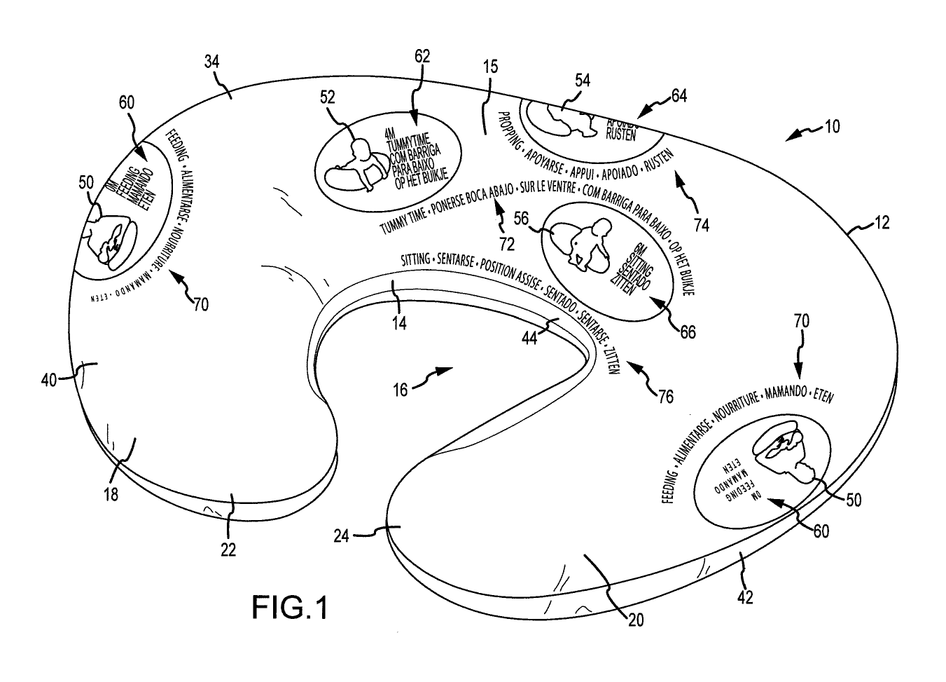

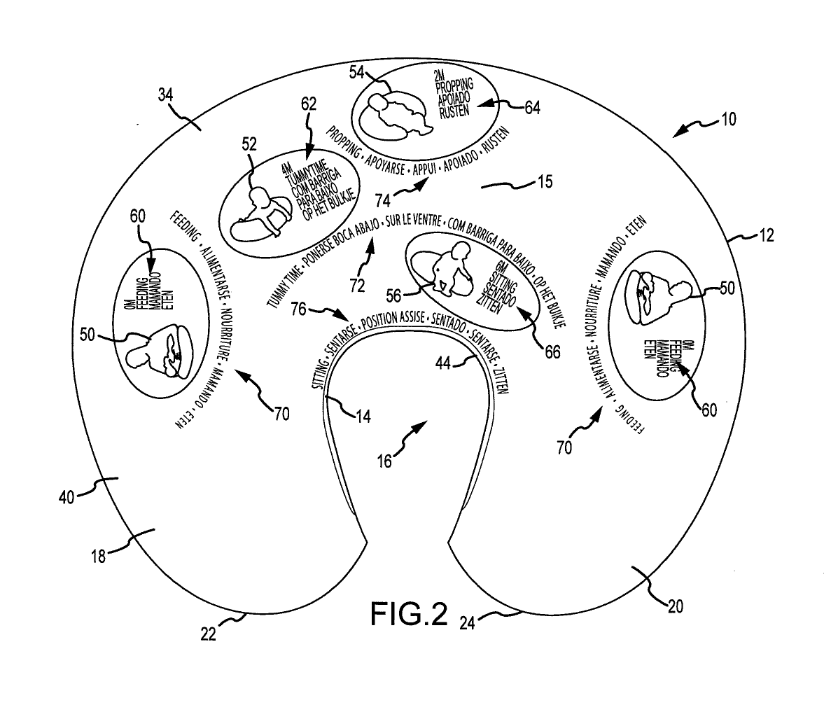

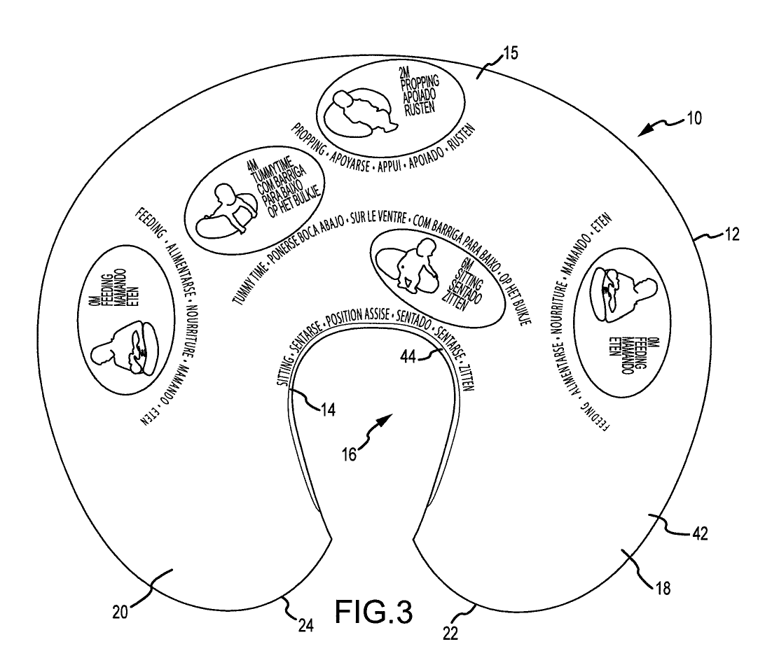

Referring now to FIGS. 1 and 2, one embodiment of a multi-use support pillow 10 will be described. Pillow 10 may be constructed to have an overall shape and feel that are similar to the support pillows described in U.S. Pat. Nos. 5,261,134, 5,661,861, 5,546,620 and 6,055,687; 6,685,024; 6,434,770; 6,671,908; 7,017,212; 6,279,185; 6,412,128; 7,451,508; 7,127,760; 6,944,898; 7,587,773; 7,472,443; and 7,404,222, previously incorporated herein by reference. However, the invention is not intended to be limited to only such support pillows, but may be used with essentially any type of pillow having two arms that may be separated from each other. Support pillow 10 includes a curved outer surface or periphery 12 which is rounded in both a longitudinal and a lateral direction to form an outer periphery. Support pillow 10 further includes a curved central inner surface or periphery 14 which defines a rounded, generally circular, curved or elliptical well region 16. While the body of the support pillow 10 is substantially continuous and uniform, with curved surfaces 12 and 14 also being continuous, it is convenient to consider the pillow body as having a medial region 15 and two opposing arms 18 and 20. The arms 18 and 20 extend in opposite directions away from the medial region 15, but are curved towards one another to give the pillow 10 its overall curved configuration. While the continuous structure does not provide a precise or exact division between the medial region 15 and each arm, considering the body of the pillow in view of these components facilitates a description of the structure and function of the pillow 10.

Arms 18 and 20 include respective ends 22 and 24, positioned remotely of the medial region 15. Support pillow 10 is proportioned so that ends 22 and 24 normally, i.e., when not under external stress, touch or are slightly separated from each another, typically within about 8 inches, usually within about 4 inches and in some cases within about 2 inches of each other. However, ends 22 and 24 do not exert substantial pressure against each other, if touching. Pillow 10 has a bilateral symmetry with respect to a central plane which passes vertically through medial region 15. Pillow 10 is also symmetrical about a mid-plane which horizontally bisects the pillow body. In some cases, it may be convenient to refer to a center line which horizontally lies along and bisects the pillow.

Well region 16 has a width that is selected to permit the support pillow to fit “snug” around the torso or waist of most users. The pillow 10 is also constructed so that the arms 18 and 20 may be moved away from each other to vary the width so that the pillow 10 may be used in a variety of applications, including larger-sized adults.

Pillow 10 includes a central core which may be constructed of a fill material, such as a hypoallergenic polyester filling. The central core is encased by a cover 34. The majority of cover 34 is constructed of a material that is compliant while generally not stretchable. Examples of such fabrics include cotton, polyesters, poly-cotton blends, or other pliant conforming fabrics. The fill material is firmly and tightly packed into cover 34, such that the core and cover 34 together provide a self-supporting pillow body, i.e., the support pillow 10 retains its shape without any sagging or drooping of arms 18 and 20 when held at the medial region 15. The tightly packed fill material forming core also provides the pillow with firmness in the sense that it will undergo only slight elastic deformation (as compared to a conventional pillow) when an object (such as a person's arms or elbows) is rested on the arms 18 and 20 or medial region 15. Other fill materials that could be used include natural or synthetic fibers, synthetic beads, feathers, foam, and organic granular fill materials such as husks and seeds and the like.

In the embodiments shown, cover 34 is formed of multiple pieces of fabric, it being appreciated that cover 34 could be constructed in other ways as well. For convenience of discussion, cover 34 can be described in terms of three major components: a top piece 40 (which forms a top surface), a bottom piece 42 (which forms a bottom surface), and a center panel or gusset 44. Examples of materials that may be used for top piece 40 and bottom piece 42 include cotton fabrics, polyester fabrics, cotton/poly blends and the like. By using such materials for the top piece 40 and bottom piece 42, various conventional fabrics may be used to provide a comfortable, decorative and aesthetically pleasing surface. Although shown with top piece 40 and bottom piece 42, it will be appreciated that a single piece of fabric or multiple pieces may be used to cover the top and bottom of the pillow. Sewn to top piece 40 and bottom piece 42 is center panel 44. In this way, center panel 44 surrounds the inner well 16 and eliminates a seam running along the mid-plane. Although the pieces may be sewn together, other techniques may also be used, such as by using glue, lacing, staples, snaps and the like. Center panel 44 permits arms 18 and 20 to be separated without tearing or bunching of the fabric that is adjacent the inner well 14. Further, the configuration the center panel 44 makes the pillow sufficiently resilient to spring arms 18 and 20 back to their original shape. Also, the center panel 44 is configured to provide a sufficient inward force on arms 18 and 20 so that they securely hold pillow 10 about an object, without being uncomfortable.

Placed onto top piece 40 are a variety of versatility messages that suggest to the user various uses of the pillow. Similarly, bottom piece 42 may also include such versatility messages so that if the pillow is flipped over the user will be able to see the versatility messages on both sides. Of course, it will be appreciated that such messages could be included on only one side. These versatility messages may be placed onto top piece 40 in a variety of ways, such as by printing, painting, sewing (directly or by a label) or the like. One type of versatility message is a use-defining image, including a feeding use-defining image 50, a tummy time use-defining image 52, a propping use-defining image 54 and a sitting use-defining image 56. Each of the use-defining images not only visually depicts a particular use but is positioned at a location on pillow body 12 so as to be suggestive of where that particular use should occur. For example, feeding use-defining image 50 may be placed at two locations, one on each of arms 18 and 20. This is suggestive of where the baby may be positioned when feeding the baby, either by nursing, bottle feeding, or the like. Typically, the baby is placed across medial region 15 and over both arms 18 and 20. Placing use-defining images on both arms 18 and 20 suggests this type of placement for the baby.

Tummy time use-defining image 52 shows a baby laying prone on a pillow and is positioned on medial region 15 near the beginning of arm 18 so that it is laterally offset from the centerline of pillow body 12, either to the left or to the right. This location for tummy time use-defining image 52 suggests that a baby may have his chest and arms supported by medial region 15 when placed in the prone position within well region 16.

Propping use-defining image 54 shows a baby being propped by a pillow when laying face up within the well region and is located at medial region 15 near outer periphery 12. This suggests that the baby's shoulders and/or head may be supported by medial region 15.

Sitting use-defining image 56 shows a baby sitting upright in the well region of a pillow and is located at medial region 15 near inner periphery 14. This suggests that the baby may sit upright in the well region 16, with his back supported by medial region 15.

Use-defining text 60, 62, 64 and 66 may also be placed adjacent to each of the use-defining images, either to the side, above and/or below the image. This text includes a single word (or a small number of words) describing the particular use. Also, this text may be in multiple languages. For example, use-defining text 60 may recite: feeding, la alimentacion. Alternatively, or in addition, other descriptive words and/or words from other languages could be used. As another example, use-defining text 62 may recite: tummy time, ponerse, boca abajo. Alternatively, or in addition, other descriptive words and/or words from other languages could be used. As a further example, use-defining text 64 may recite: propping, apoyarse. Alternatively, or in addition, other descriptive words and/or words from other languages could be used. In a further example, use-defining text 66 may recite: sitting, sentarse. Alternatively, or in addition, other descriptive words and/or words from other languages could be used.

Because of space limitations, only a limited amount of use-defining text may be placed adjacent to the use-defining images. As such, more elaborate text and/or additional languages may be included at other locations on pillow body 12 to describe the particular use. For example, additional use-defining text 70, 72, 74 and 76 may be used. As one example, additional use-defining text 70 may be positioned below feeding use-defining image 50 and may recite: feeding•alimentarse•nourriture•mamando•eten. Alternatively, or in addition, additional descriptive words and/or words from other languages could be used.

As another example, additional use-defining text 72 may be positioned below tummy time use-defining image 52 and may recite: tummy time•ponerse boca abajo•sur leventre•com barrigapara baxixo•op hetbuikje. Alternatively, or in addition, additional descriptive words and/or words from other languages could be used.

As a further example, additional use-defining text 74 may be positioned below propping use-defining image 54 and may recite: propping •apoyarse•appui•apoiado•rusten. Alternatively, or in addition, additional descriptive words and/or words from other languages could be used.

As still another example, additional use-defining text 76 may be positioned below sitting use-defining image 56 and may recite: sitting•sentarse•position assise•sentado•sentarse•zitten. Alternatively, or in addition, additional descriptive words and/or words from other languages could be used.

In some cases, the pillow may include only use-defining text or only use-defining images. Use of both text and images helps to quickly provide use information to the user in a variety of formats.

As another option numbers and/or other symbols and/or text may be included by each use-defining image to give an age range for a suggested use. For instance, adjacent feeding use-defining image 50 may be: 0 M. This indicates that feeding is appropriate for newborn infants and above. As another example, adjacent tummy time use-defining image 52 may be: 4 M. This indicates that tummy time is appropriate for babies about 4 months and above. As a further example, adjacent propping use-defining image 54 may be: 2 M. This indicates that propping is appropriate for babies about 2 months and above. As a further example, adjacent sitting use-defining image 56 may be: 6 M. This indicates that sitting is appropriate for babies about 6 months and above.

In some cases, colors may be used to coordinate the use-defining images and use-defining text. For instance, use-defining images 50-56, use-defining text 60-66 and additional use-defining text 70-76 may be color coded so that a user can easily match the appropriate text with the corresponding image. For example, use-defining image 50, use-defining text 60 and additional use-defining text 70 that all relate to feeding could be in pink. Similarly, the tummy time information could all be in blue, the propping all in red and sitting all in green.

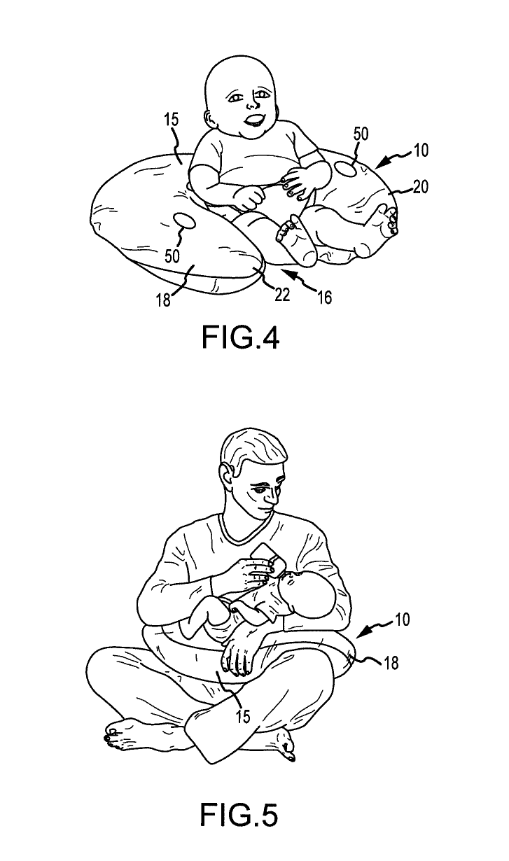

Referring now to FIG. 4, one use of pillow 10 for assisting a baby with sitting will be described. Pillow 10 is placed on a generally flat surface and a baby is placed within well region 16 in a sitting position. The baby's back is supported by medial region 15. In so doing, the baby's back covers sitting use-defining image 66 which signifies a location for sitting.

FIG. 5 illustrates use of pillow 10 when feeding a baby. Pillow 10 is placed on the caregiver's lap, with arms 18 and 20 resting on the caregiver's legs in the zone underneath where feeding use-defining images 50 are located. Medial region 15 extends across the caregiver's lap, and the baby is positioned across medial region 15 and the upper portion of arms 18 and 20. In this way, the baby is in a more comfortable feeding position while bottle feeding, while nursing, sleeping, resting or the like.

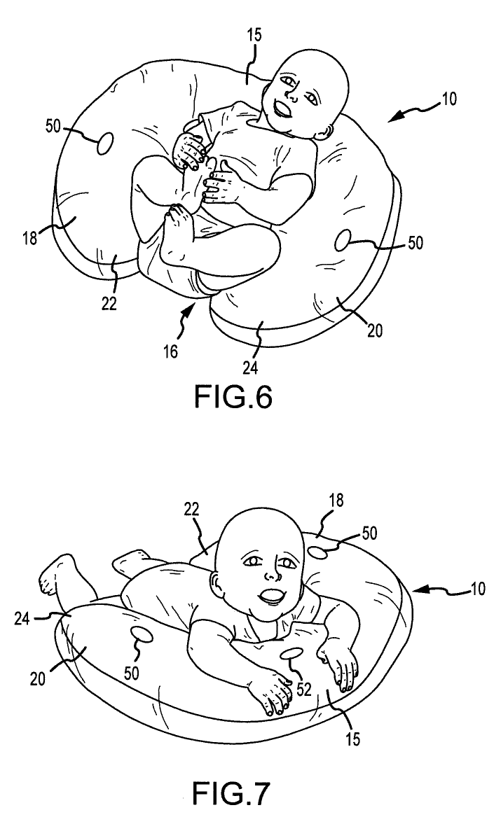

FIG. 6 illustrates pillow 10 being used to prop a baby. As shown, pillow 10 is on a generally flat surface and the baby is leaning back in the supine position, with medial region 15 supporting the baby's back, neck and head. Also, the baby is secured within well region 16. When leaning back, the baby covers propping use-defining image 54 which is indicative of where the baby should be supported by pillow 10.

In FIG. 7, a baby is in the prone position, also referred to as tummy time. As shown, pillow 10 is on a generally flat surface and the baby's stomach is held within well region 16. The baby's chest and arms are supported by medial region 15 in the region where tummy time use-defining image 52 is located.

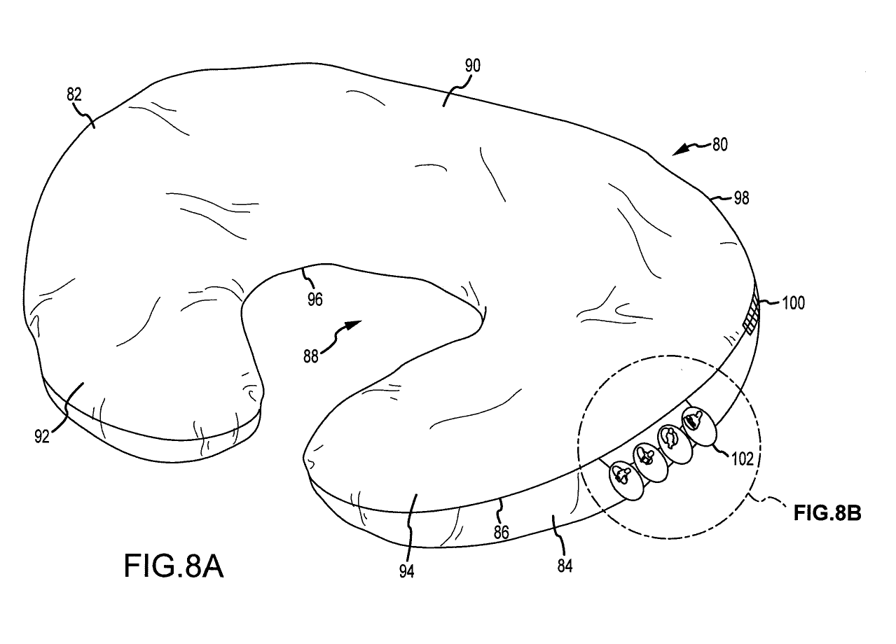

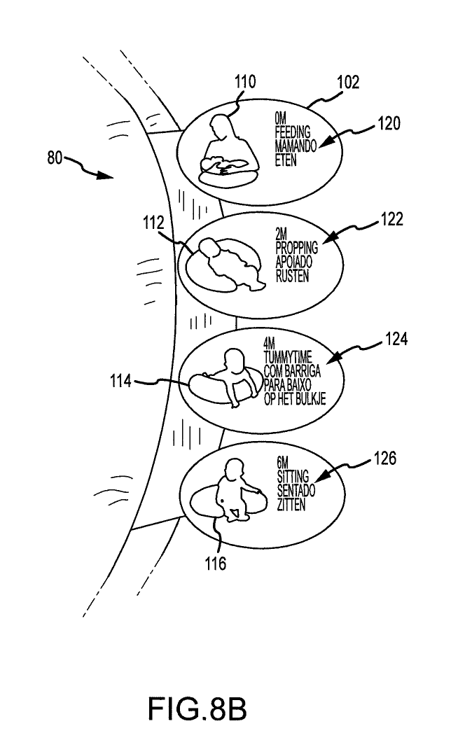

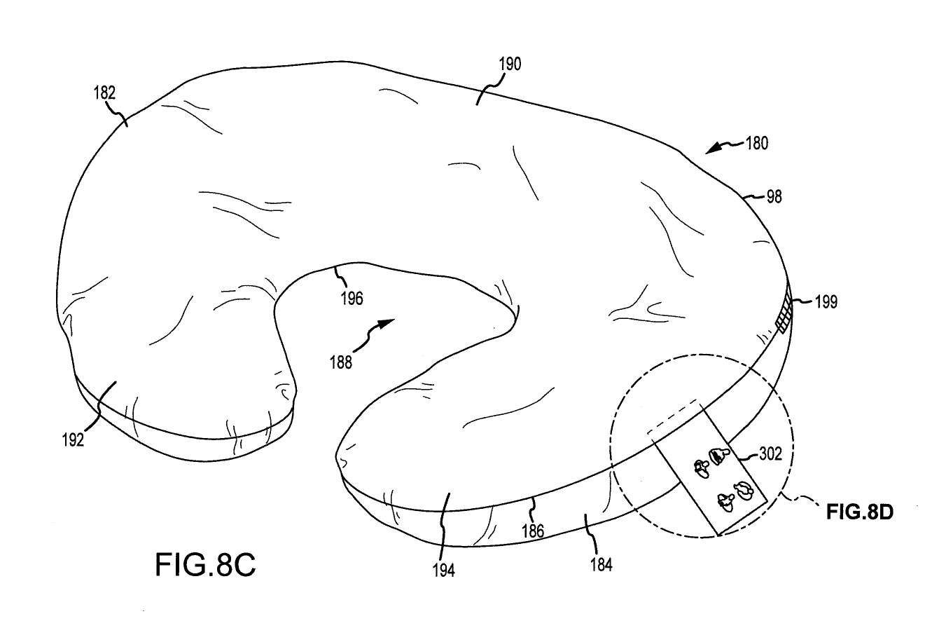

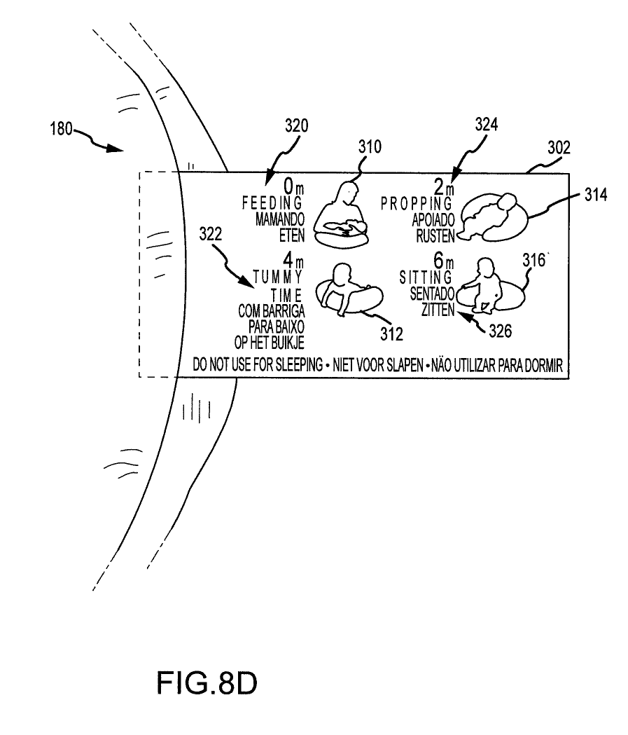

FIGS. 8A and 8B illustrate one embodiment of a slipcover 80 that may be placed over a multi-use support pillow, such as pillow 10 or 210. Slipcover 80 may be constructed of a top piece 82 and a bottom piece 84 that are sewn together along a seam 86 to form an open interior. Optionally, a center gusset similar to gusset 44 of pillow 10 could also be positioned between top piece 82 and bottom piece 84 near a well region 88. Slipcover 80 also includes a medial region 90, two arms 92 and 94, an inner periphery 96 and an outer periphery 98. Outer periphery 98 may include an opening that permits the pillow to be inserted into the interior of slipcover 80. A fastening mechanism, such as a zipper 100, may be used to close the opening. The opening may be positioned at other locations, and other fastening mechanisms may be used as well.

Sewn into seam 86 at outer periphery 98 is a tag 102 and is shown in greater detail in FIG. 8B. Although shown on arm 94, tag 102 could be located anywhere along slipcover 90, although placement on outer periphery 98 helps to keep the tag away from the baby. Also, the tag could be directly sewn to the fabric at any location, or could even be printed onto the slipcover. Further, tag 102 (or any of the tags described herein) could be sewn or coupled directly to any of the pillows described herein, including pillows 10 and 210, in a manner similar to how tag 102 is coupled to the slipcover. As such, the tags described herein are not limited only for use with slipcovers.

Tag 102 includes multiple use-defining images, including a feeding use-defining image 110, a tummy time use-defining image 112, a propping use-defining image 114 and a sitting use-defining image 116 that may be similar to those described in connection with pillow 10. Also, use-defining text 120, 122, 124 and 126 may also be placed adjacent to each of the use-defining images similar to pillow 10. This text includes a single word (or a small number of words) describing the particular use. Also, this text may be in multiple languages. For example, use-defining text 120 may recite: feeding, la alimentacion. Alternatively, or in addition, other descriptive words and/or words from other languages could be used. As another example, use-defining text 122 may recite: tummy time, ponerse, boca abajo. Alternatively, or in addition, other descriptive words and/or words from other languages could be used. As a further example, use-defining text 124 may recite: propping, apoyarse. Alternatively, or in addition, other descriptive words and/or words from other languages could be used. In a further example, use-defining text 126 may recite: sitting, sentarse. Alternatively, or in addition, other descriptive words and/or words from other languages could be used. Further, some of this text (or additional text in additional languages) may also be provided on the opposite side of tag 102. Also, similar to pillow 10, information may be provided as to a recommended age for each of the uses.

FIGS. 8C and 8D illustrate a further embodiment of a slipcover 180 that may be placed over a multi-use support pillow, such as pillow 10 or 210. Slipcover 180 may be constructed to be similar to slipcover 80 and include a top piece 182 and a bottom piece 184 that are sewn together along a seam 186 to form an open interior. Optionally, a center gusset similar to gusset 44 of pillow 10 could also be positioned between top piece 182 and bottom piece 184 near a well region 188. Slipcover 180 also includes a medial region 190, two arms 192 and 194, an inner periphery 196 and an outer periphery 198. Outer periphery 198 may include an opening that permits the pillow to be inserted into the interior of slipcover 180. A fastening mechanism, such as a zipper 199, may be used to close the opening. The opening may be positioned at other locations, and other fastening mechanisms may be used as well.

Sewn into seam 186 at outer periphery 198 is a tag 302 and is shown in greater detail in FIG. 8D. Although shown on arm 194, tag 302 could be located anywhere along slipcover 180, although placement on outer periphery 198 helps to keep the tag away from the baby. Also, the tag could be directly sewn to the fabric at any location, or could even be printed onto the slipcover. Further, tag 302 (or any of the tags described herein) could be sewn or coupled directly to any of the pillows or slipcovers described herein, including pillows 10 and 210, in a manner similar to how tag 302 is coupled to the slipcover. As such, the tags described herein are not limited only for use with slipcovers.

The information included on tag 302 may be strategically placed so as to maximize visibility. For example, tag 302 may include ends 304 and 305. End 304 may not include any information, except for an optional sew line indicator where tag 302 is to be sewn into seam 186. In this way, end 304, which will not be visible once tag 302 is coupled to slipcover 180, need to include any printed information. The optional sew line indicates where tag 302 may be sewn into seam 186. Further, it will be appreciated that the opposite side of tag 302 may include identical or similar information so that, regardless of which side of tag 302 is in view, the information may be visualized.

Tag 302 includes multiple use-defining images, including a feeding use-defining image 310, a tummy time use-defining image 312, a propping use-defining image 314 and a sitting use-defining image 316 that may be similar to those described in connection with pillow 10 or tag 102. Also, use-defining text 320, 322, 324 and 326 may also be placed adjacent to each of the use-defining images. This text includes a single word (or a small number of words) describing the particular use. Also, this text may be in multiple languages. For example, use-defining text 320 may recite: feeding, mamando, eten. Alternatively, or in addition, other descriptive words and/or words from other languages could be used. As another example, use-defining text 322 may recite: tummy time, corn barriga, para baixo, op het buikje. Alternatively, or in addition, other descriptive words and/or words from other languages could be used. As a further example, use-defining text 324 may recite: propping, apoiado, rusten. Alternatively, or in addition, other descriptive words and/or words from other languages could be used. In a further example, use-defining text 326 may recite: sitting, sentado, zitten. Alternatively, or in addition, other descriptive words and/or words from other languages could be used. Further, some of this text (or additional text in additional languages) may also be provided on the opposite side of tag 302.

Also, similar to pillow 10, information may be provided as to a recommended age for each of the uses. For example, the recommended age for feeding is 0 months, meaning that the pillow may be used for feeding at any age, the age for tummy time is 4 months and above, propping is 2 months and above, and the age for sitting is 6 months and above.

The use-defining text may all be arranged in a single column adjacent the appropriate use defining image, although other orientations are possible, such as by placing the recommend age above or below the image. Further, the text and associated images as shown may be arranged in two columns, with each column having two images. This particular orientation maximizes visibility while minimizing the size of tag 302. However, other arrangements are possible.

In some cases, warnings or other usage information may be included on tag 302. For example, a bottom edge of tag 302 may include information indicating that the pillow should not be used for sleeping. This information may be provided in various languages, and include text such as: Do not use for sleeping, niet voor slapen, nao utilizer para dormer.

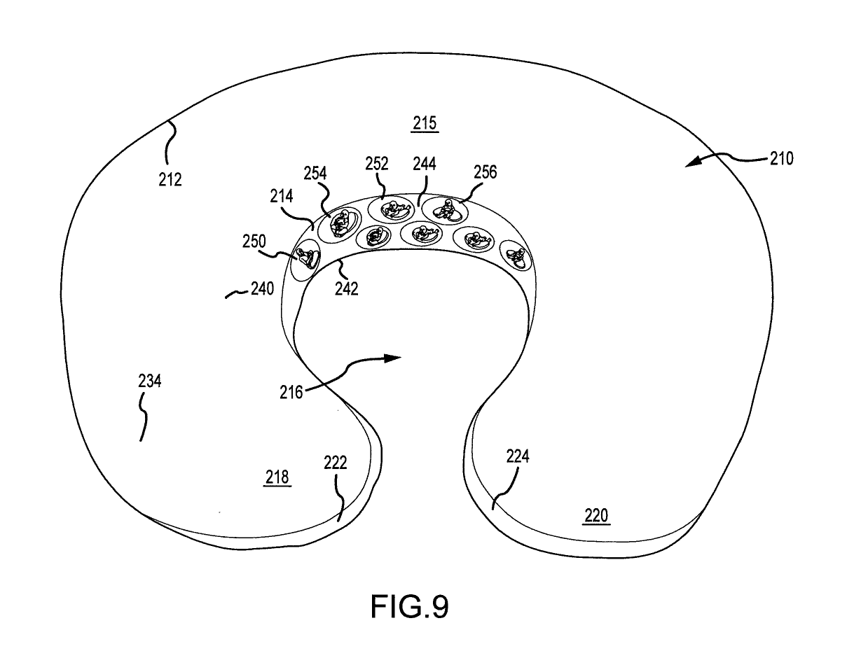

FIG. 9 illustrates a top perspective view of another embodiment of a multi-use pillow 210 according to the invention. Pillow 210 may be constructed in a manner similar to pillow 10 and includes a curved outer surface or periphery 212 and a curved central inner surface or periphery 214 which defines a rounded, generally circular, curved or elliptical well region 216. The pillow body may be defined in terms of a medial region 215 and two opposing arms 218 and 220. Arms 218 and 220 include respective ends 222 and 224, positioned remotely of the medial region 215.

Pillow 210 includes a central core which may be constructed of a fill material, such as a hypoallergenic polyester filling. The central core is encased by a cover 234. The majority of cover 234 is constructed of a material that is compliant while generally not stretchable. For convenience of discussion, cover 234 can be described in terms of three major components: a top piece 240 (which forms a top surface), a bottom piece 242 (which forms a bottom surface), and a center panel or gusset 244. Examples of materials that may be used for top piece 240 and bottom piece 242 include cotton fabrics, polyester fabrics, cotton/poly blends and the like. Sewn or otherwise coupled to top piece 240 and bottom piece 242 is center panel 244. In this way, center panel 244 surrounds the inner well 216 and eliminates a seam running along the mid-plane. Although the pieces may be sewn together, other techniques may also be used, such as by using glue, lacing, staples, snaps and the like. Center panel 244 permits arms 218 and 220 to be separated without tearing or bunching of the fabric that is adjacent the inner well 214. Further, the configuration the center panel 244 makes the pillow sufficiently resilient to spring arms 218 and 220 back to their original shape. Also, the center panel 244 is configured to provide a sufficient inward force on arms 218 and 220 so that they securely hold pillow 210 about an object, without being uncomfortable.

Gusset 244 may be constructed of a woven material cut on the bias. Such woven materials may have a weft and a weave. Gusset 244 is coupled to top piece 240 and bottom piece 242 so that the weft and the weave are at about a 45 degree angle relative to a center-line of the pillow that runs longitudinally along gusset 244 in a manner similar to that described in copending U.S. Publication No. 2008/0010750, previously incorporated by reference. This permits gusset 244 to resiliently expand and contract as the arms 218 and 220 are separated from each other and released.

Gusset 244 also includes versatility messages, including any of the versatility messages described in connection with other embodiments. These versatility messages, in this embodiment, may be provided only on gusset 244. In this way, the cost to manufacture the pillow may be greatly reduced, as the versatility messages are only included on the gusset 244 (rather than on top and bottom pieces 240 and 242). Another advantage of including the versatility messages on gusset 244 is that if the pillow is used with a slip cover that is somewhat see-through, positioning the messages on gusset 244 ensures that they will not be seen through the slipcover when looking at the pillow from the top.

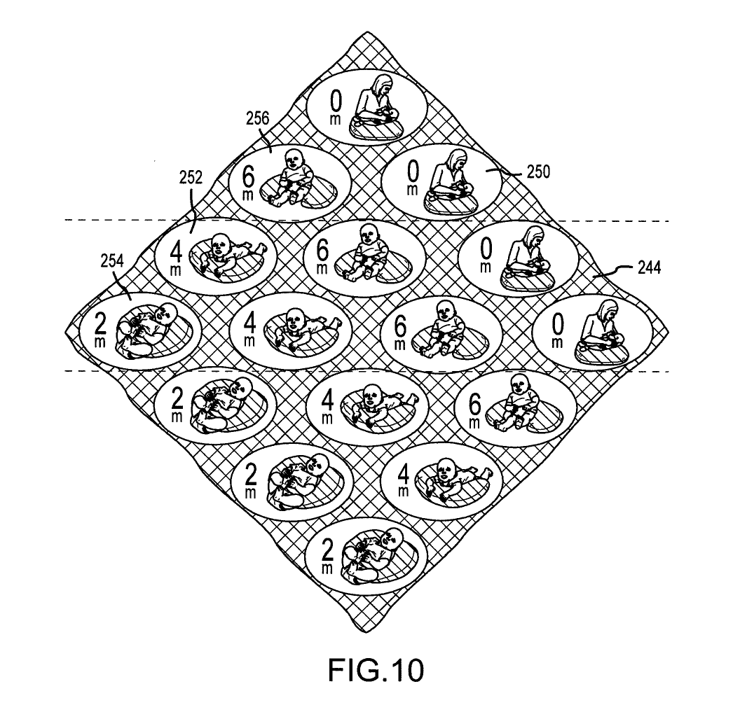

The versatility messaging, can include, for example, one or more use-defining images, numeric indicia, text, and the like, similar to other embodiments. For example, as also shown in FIG. 10, gusset 244 may include one or more feeding use-defining images 250. This image is suggestive of where the baby may be positioned when feeding the baby, either by nursing, bottle feeding, or the like. Tummy time use-defining image 252 shows a baby laying prone on a pillow and suggests that a baby may have his chest and arms supported by medial region 215 when placed in the prone position within well region 216. Propping use-defining image 254 shows a baby being propped by a pillow when laying face up within the well region to suggest that the baby's shoulders and/or head may be supported by medial region 215. Sitting use-defining image 256 shows a baby sitting upright in the well region of a pillow to suggest that the baby may sit upright in the well region 216, with his back supported by medial region 215.

Use-defining images 250, 252, 254 and 256 may be arranged on gusset 244 in a variety of ways. As also shown in FIG. 10, these use-defining images may be arranged in columns, that in some cases may be somewhat off vertical, such as on a 45 degree diagonal relative to the centerline of the pillow. For example, as shown in FIG. 10, two spaced apart cut and/or sew lines are shown in dashed line. These lines represent where the fabric will be cut and/or sewn when forming the gusset and/or sewing it to the slipcover and/or pillow. These lines are parallel to the centerline of the pillow body and are spaced apart so that two rows of images may be produced and displayed as shown (it being appreciated that only a partial piece of the fabric is shown in FIG. 10).

The positioning/spacing of the use-defining images on a 45 degree diagonal as shown is particularly useful when the gusset is to be cut and sewn on the bias. Printing the images at this angle permits a full set of images to be displayed with a limited amount of fabric that is used for the gusset, while permitting the gusset to be appropriately oriented so that it can be cut and sewn on the bias as described herein. For example, in FIG. 10 grid lines are used to show the direction of the weft and the weave of the fabric and how the images are positioned 45 degrees relative to the weft and the weave (as well as to the two dashed lines described above). In order to obtain the benefits of the resilient nature of the fabric, the gusset is sewn to the cover with the weft and the weave approximately 45 degrees relative to the centerline, thus dictating the orientation of the use-defining images as described above. If a gusset was used that was not cut and sewn on the bias, the use-defining images could be printed straight across the fabric, or in any other orientation. Hence, as other options, the use-defining images could be arranged in straight horizontal rows or vertical columns, randomly arranged, and need not necessarily have two of the same images adjacent each other.

As with other embodiments, numbers and/or other symbols and/or text may be included by each use-defining image to give an age range for a suggested use. For instance, adjacent feeding use-defining image 250 may be: 0 M. This indicates that feeding is appropriate for newborn infants and above. As another example, adjacent tummy time use-defining image 252 may be: 4 M. This indicates that tummy time is appropriate for babies about 4 months and above. As a further example, adjacent propping use-defining image 254 may be: 2 M. This indicates that propping is appropriate for babies about 2 months and above. As a further example, adjacent sitting use-defining image 256 may be: 6 M. This indicates that sitting is appropriate for babies about 6 months and above.

Also similar to other embodiments, use-defining text may also be placed adjacent to each of the use-defining images, either to the side, above and/or below the image. This text includes a single word (or a small number of words) describing the particular use. Also, this text may be in multiple languages.

Further, the various images may follow a color coding scheme similar to other embodiments. For instance, use-defining images 250-256, any optional use-defining text or numeric indicia may be color coded so that a user can easily match the appropriate text with the corresponding image. For example, use-defining image 250, any use-defining text and numeric indicia that all relate to feeding could be in the same color. Similarly, the tummy time information could all be in another color, the propping information all in yet another color and sitting information all in still a further color.

In some cases, as shown in FIGS. 9 and 10, color distinctions may be made between use-defining images and the rest of the gusset 244. In this way, colors may be used to form a type of background to help the user's eyes focus on the use-defining images. The background color(s) may be solid or patterned (such as striped) and may optionally form a shape around each use-defining image, such as a circle, oval, square, rectangle, triangle, amorphous shape, and the like. This allows the user to easily focus on the use-defining image.

The invention has now been described in detail for purposes of clarity and understanding. However, it will be appreciated that certain changes and modifications may be practiced within the scope of the appended claims.

What is claimed is:

1. A multi-use pillow, comprising:
a pillow body comprising a medial region and two arms that extend from the medial region, wherein the pillow body has a curved exterior periphery and an interior periphery that defines a well;
a plurality of use-defining images positioned on the pillow body; and
numeric indicia adjacent the use-defining images giving a suggested age for the associated use.

2. A pillow as in claim 1, wherein the pillow body comprises a fabric shell encasing a fill material, and wherein the use-defining images are printed onto the shell.

3. A pillow as in claim 2, wherein the shell comprises a top piece, a bottom piece and a gusset disposed between the top piece and the bottom piece at the inner periphery, and wherein the use-defining images are included on the gusset.

4. A pillow as in claim 2, wherein the top piece and the bottom piece do not include any use-defining images.

5. A pillow as in claim 3, wherein the gusset is constructed of a fabric cut on the bias having a weft and a weave such that the use-defining images are disposed at a 45 degree angle relative to the weft and the weave.

6. A pillow as in claim 1, wherein the use-defining images are positioned at locations indicative of where a particular use of the pillow may occur.

7. A pillow as in claim 1, further comprising use-defining text on the pillow body adjacent to each of the use-defining images, wherein the use-defining text describes the particular use associated with each of the use-defining images.

8. A pillow as in claim 1, wherein the particular use comprises sitting upright within the well, and wherein the use-defining image comprises a baby sitting in a well of a pillow.

9. A pillow as in claim 1, wherein the particular use comprises laying face up within the well while being propped by the medial region, and wherein the use-defining image comprises a baby being propped by a pillow.

10. A pillow as in claim 1, wherein the particular use comprises feeding, and wherein the use-defining image comprises a baby resting atop a pillow.

11. A pillow as in claim 1, wherein the particular use comprises laying prone, and wherein the use-defining image comprises a baby laying prone on a pillow.

12. A pillow as in claim 2, wherein the use-defining images and the numeric indicia are color-coded, with corresponding images and numeric indicia being of the same color.

13. A pillow as in claim 2, wherein the use-defining images are provided at multiple locations.

14. A pillow as in claim 1, further comprising a slipcover disposed about the pillow body, wherein the slipcover also includes use-defining images.

15. A method for using a pillow, the method comprising:
providing a pillow body comprising a medial region and two arms that extend from the medial region, wherein the pillow body has a curved exterior periphery and an interior periphery that defines a well, and wherein the pillow body includes a plurality of use-defining images positioned on the pillow body and numeric indicia adjacent the use-defining images giving a suggested age for the associated use; and
positioning a baby at least partially on the pillow body or within the well in a position depicted in one of the use-defining images.

16. A method as in claim 15, wherein the pillow body comprises a fabric shell encasing a fill material, and wherein the use-defining images are printed onto the shell.

17. A method as in claim 16, wherein the shell comprises a top piece, a bottom piece and a gusset disposed between the top piece and the bottom piece at the inner periphery, and wherein the use-defining images are included on the gusset.

18. A method as in claim 17, wherein the top piece and the bottom piece do not include any use-defining images.

19. A method as in claim 17, wherein the gusset is constructed of a fabric cut on the bias having a weft and a weave such that the use-defining images are disposed at a 45 degree angle relative to the weft and the weave.

20. A method as in claim 15, wherein the use-defining images are provided at locations indicative of where a particular use of the pillow may occur, and use-defining text on the pillow body adjacent to each of the use-defining images, wherein the use-defining text describes the particular use associated with each of the use-defining images.

21. A method as in claim 15, further comprising readjusting the position of the baby relative to the pillow such that the baby is in a position similar to another one of the use-defining images.
